(19) United States
(12) Patent Application Publication
(10) Pub. No.: US 2023/0393387 A1
(43) Pub. Date: Dec. 7, 2023

(54) GHOST IMAGE FREE PROJECTION AT ARBITRARY DISTANCE

(71) Applicant: CAMBRIDGE ENTERPRISE LIMITED, Cambridge, Cambridgeshire (GB)

(72) Inventors: Daping Chu, Cambridge, Cambridgeshire (GB); Yuanbo Deng, Cambridge, Cambridgeshire (GB)

(21) Appl. No.: 18/033,225

(22) PCT Filed: Oct. 21, 2021
(86) PCT No.: PCT/GB2021/052721

§ 371 Date: Apr. 21, 2023

(30) Foreign Application Priority Data
Oct. 23, 2020 (GB) 2016870.4

(51) Int. Cl. G02B 27/00; G02B 27/01; G02B 5/02

(52) U.S. Cl. CPC G02B 27/0018; G02B 5/0252; G02B 27/0103

(57) ABSTRACT

An image generation system for providing a ghost image free head-up display, the system comprising a display screen having a front surface and a back surface, a picture generation unit for projecting an image towards the display screen for reflection towards an eye box, a field lens, and an anisotropic optical component having a first optical power along a first axis and second optical power along a second axis, wherein the first and second axis are perpendicular, wherein the picture generation unit is configured to project light through the field lens such that light is incident on the front surface of the display screen forming a first virtual image, wherein a portion of the light is transmitted through the display screen and is incident on the back surface of the display screen forming a second virtual image, wherein the first and second virtual images are offset along the first axis, wherein the field lens is configured to project the first virtual image at a first projection distance and the second virtual image at a second projection distance such that the offset is below a threshold magnitude and the first and second virtual images are substantially overlaid as viewed from the eye box, and wherein the anisotropic optical component is configured to magnify the first and second virtual image along the second axis only.

### TECHNICAL FIELD

The present disclosure relates to a display system. Particularly, but not exclusively, the disclosure relates to apparatus for displaying images on a screen in a ghost image free manner at an arbitrary projection distance.

### BACKGROUND

Heads-up displays (HUDs) are known displays where images are projected onto a transparent surface, such as a windscreen or visor. Such displays are well known in a number of different environments including in vehicles.

Within the automotive industry, most commercial HUDs utilize a separate optical screen (combiner-type HUDs), or display directly onto the windshield (windscreen-type HUDs). Combiner-type HUDs can be installed in most types of cars without a great deal of modifications. They utilize a transparent plastic projector screen to combine the real driving environment and the projected virtual image. Whilst relatively cheap to install, the plastic screen will partially obscure the view of the driver, and furthermore its performance is poor when the unit experiences vibrations.

Windscreen-type HUDs utilize a vehicle's windscreen to combine a virtual image and real environment. As the windscreen has a finite thickness (typically much greater than the screens used in combiner-type HUDs), the projected image will be reflected both at the front and the back surface of the windscreen, resulting in a primary image and an secondary offset ‘ghost’ image. The term ghost image is used in the art, and throughout the specification to describe the secondary offset image. In order to negate this effect, a special film can be applied to the windscreen that enhances reflection at the front surface (thereby reducing subsequent reflection at the back surface and diminishing the ghost image). Whilst relatively low cost, such films can be visually unappealing, adversely affect image quality and can decreased in effectiveness following long-term exposure to sunlight. Another solution is to provide a special multi-layer, wedged windscreen which effectively overlap the two reflected images, such that the driver is presented with single, clear image. A schematic of a wedged windscreen is shown in FIG. 1. These specially produced windscreens must be designed especially for each application, and are expensive to build.

An alternative approach is to engineer a windscreen with one or more layers of emissive/scattering nanoparticles. Each layer will generate a visible emission at one of R/G/B waveband when excited by a scanning laser projector. By overlaying the images of multiple wavebands, a coloured image is displayed on the windshield. This so-called full windscreen HUD has an unlimited viewing angle, unlimited display site and no laser speckle, but are again expensive and complicated to produce. Further, as the driver has to focus on the windscreen in order to view the displayed information, multi-depth images (i.e. images having elements at different apparent depths) cannot be experienced.

A further difficulty arises when designing HUDs for applications in which the windscreen has a large tilting angle, such as those found in trains and lorries. For small cars, the tilting angle of the windscreen is usually between 30° and 45° and the HUD system is installed just beneath the dashboard, making it easier to design the HUD system. For larger vehicles however, the tilting angles of windscreens can vary over a while range. For example, most train windscreens have a tilting angle from 60° to 80. As for trucks and buses, the tilting angle can be even higher—up to 90°. Not only does the larger tilting angle, in combination with the thicker windscreens used in larger vehicles, make the ghost image problem more prominent by increasing the offset of the images reflected from the front and back surface of the windscreen, it also increases the cost of the conventional mitigation techniques discussed above.

As such the existing methods do not allow for the reduction of ghost images across multiple different systems.

An object of the present invention is to mitigate some of the deficiencies of the prior art mentioned above.

### SUMMARY OF THE INVENTION

Aspects and embodiments of the invention provide apparatus as claimed in the appended claims.

According to a first aspect of the invention there is provided an image generation system for providing a ghost image free head-up display, the system comprising a display screen having a front surface and a back surface, a picture generation unit for projecting an image towards the display screen for reflection towards an eye box, a field lens, and an anisotropic optical component having a first optical power along a first axis and second optical power along a second axis, wherein the first and second axis are perpendicular, wherein the picture generation unit is configured to project light through the field lens such that light is incident on the front surface of the display screen forming a first virtual image, wherein a portion of the light is transmitted through the display screen and is incident on the back surface of the display screen forming a second virtual image, wherein the first and second virtual images are offset along the first axis, wherein the field lens is configured to project the first virtual image at a first projection distance and the second virtual image at a second projection distance such that the offset is below a threshold magnitude and the first and second virtual images are substantially overlaid as viewed from the eye box, and wherein the anisotropic optical component is configured to magnify the first and second virtual image along the second axis only.

This approach allows for ghost image free projection without the need for any modification to the display screen surface or internal structure. It further allows for images to be displayed at a shorter apparent projection distance than would otherwise be required to eliminate the ghost image.

Optionally, the field lens is configured to project the first and second virtual images at the first and second projection distances such that the offset between the first and second virtual image is below a threshold angular resolution.

Optionally, the threshold angular resolution is equal to the dimensions of a pixel.

Optionally, the threshold angular resolution is equal to the angular resolution of the human eye. By reducing the offset below the limits of the display and/or the human eye's ability to resolve, the ghost image is effectively eliminated.

Optionally, the anisotropic optical component is provided by one of a free form mirror, free form lens, cylindrical mirror or a cylindrical lens.

Optionally, the field lens is provided by one of a concave mirror, a free-form surface, a Fresnel lens, a waveguide, a diffractive optical element, a holographic optical element or one or more tapered optical fibers. Tapered optical fibers in particular allow for lensless magnification of the projected image fiberspace, thereby shortening the optical path of the light and allowing the overall spatial footprint of the system to be reduced.

Optionally, the picture generation unit comprises a light source and a spatial light modulator.

Optionally, the picture generation unit comprises a projector and a diffuser for realising a projected image.

Optionally, the picture generation unit comprises a laser and a 2D scanning mirror.

Optionally, the picture generation unit comprises a holographic unit to produce computer generated holograms and a diffuser for realising the holograms.

Optionally, the picture generation unit comprises one or more of a LCD device, a LED device, a micro LED device, a OLED device or a digital light processing digital micromirror device.

Such devices are capable of being activated by the application of current, which can be localised and modulated as desired. They can further provide a flexible, multi-colour display.

Optionally, the system further comprises intervening optics between any of the picture generation unit, the field lens, the display screen and/or the anisotropic optical component.

Such intervening optics allow the path of the light to be arranged around the physical confines of the installation environment, as well as compensating for any optical effects of the windscreen itself.

Optionally, the intervening optics comprise one of a fold mirror, waveguide, diffractive optical element or holographic optical element.

Optionally, the system further comprises an image processor in communication with the picture generation unit, wherein the image processor is configured to account for distortions caused by the optical set up such that the images appears undistorted on the display screen. This obviates the need for any post-image generation corrections as well as bulky correction optics. Furthermore, it provides a higher degree of flexibility which can adapt to different display surfaces and optical setups.

Optionally, the display screen of the head-up display is a windscreen of a vehicle.

Optionally, one or more of the field lens, projection unit, anisotropic optical component and/or intervening optical components (if present) are moveable relative to one another.

Optionally, the image comprises a first region and a second region, wherein the system is arranged such that the first and second region are projected through the field lens whilst only the second region is projected through the anisotropic optical component. The projection of an image at multiple distances through the HUD system can produce a convincing representation of a real object.

According to a second aspect of the invention there is provided a method for providing a ghost image free head-up display, the method comprising generating an image at a picture generation unit, said image to be rendered on a display screen for reflection towards a predetermined eye box, the display screen having a front surface and a back surface, providing a field lens between the picture generation unit and the display screen, providing an anisotropic optical component between the picture generation unit and the display screen, the anisotropic optical component having a first optical power along a first axis and second optical power along a second axis, wherein the first and second axis are perpendicular, wherein a portion of the light incident on the front surface of the display screen is reflected forming a first virtual image, and a portion of the light is transmitted through the display screen and is incident on the back surface forming a second virtual image, wherein the first and second virtual images are offset along the first axis, configuring the field lens to project the first virtual image at a first projection distance and the second virtual image at a second projection distance such that the offset is below a threshold magnitude and the first and second virtual images are substantially overlaid as viewed from the eye box, and configuring the anisotropic optical component to magnify the first and second virtual image along the second axis only.

Other aspects of the invention will be apparent from the appended claim set.

### BRIEF DESCRIPTION OF THE DRAWINGS

One or more embodiments of the invention will now be described, by way of example only, with reference to the accompanying drawings, in which:

FIG. 1 is a schematic illustration of the HUD system according to an embodiment of the invention.

FIGS. 2 and 3 depict the principles of image formation of a cylindrical mirror.

FIG. 4 is a schematic illustration of the HUD system according to an embodiment of the invention.

FIG. 5 is a schematic illustration of the HUD system according to an embodiment of the invention.

FIG. 6 is a schematic illustration of the HUD system according to an embodiment of the invention.

FIG. 7 provides multiple schematic illustrations of the HUD system according to an several embodiment of the invention.

FIG. 8 is a schematic illustration of the HUD system according to an embodiment of the invention.

FIG. 9 is a schematic illustration of the HUD system according to an embodiment of the invention.

FIGS. 10, 11 and 12 show simulation results of the HUD system according to an embodiment of the invention.

FIG. 13 is a schematic illustration of the HUD system according to an embodiment of the invention.

FIGS. 14, 15 and 16 show simulation results of the HUD system according to an embodiment of the invention.

### DETAILED DESCRIPTION

In an aspect of the invention the apparatus and the display are installed in a vehicle, such as a motor vehicle. Whilst the following description is described with reference to a HUD of a motor vehicle utilising the windscreen as the display screen, the disclosure, and concepts described herein are applicable to other forms of HUD (for example those installed on other forms of vehicles, wearable platforms such as helmets or goggles or other known types of HUDs), as well as displays in general.

In particular, it is envisaged that the invention is installed for use in a confined environment such as a vehicle which can be operated on land (on/off road, or track), under or over sea, in air or space. The examples can be, but not limited to, cars, buses, lorries, excavators, exoskeleton suit for heavy-duty tasks, motorcycles, trains, theme park rides; submarines, ships, boats, yachts, jet-skies and other types of sea vehicles; planes, gliders and other types of air crafts, spaceships and shuttles for space crafts. Furthermore, the technology can be installed/integrated in a mobile platform such as a driver's/operator's head/eye protection apparatus such as a helmet or goggles. Therefore, any activity, which involves in wearing protective helmets/goggles, can utilise the invention described herein. These protective helmets/goggles can be worn, but not limited to, by motorcyclist/cyclist, skiers, astronauts, exoskeleton operators, military personnel, miners, scuba divers and construction workers. Moreover, it can be used in a standalone environment for game consoles, arcade machines and with a combination of an external 2D/3D display it can be used as a simulation platform. Also, it can be used in institutions and museums for educational and entertainment purposes.

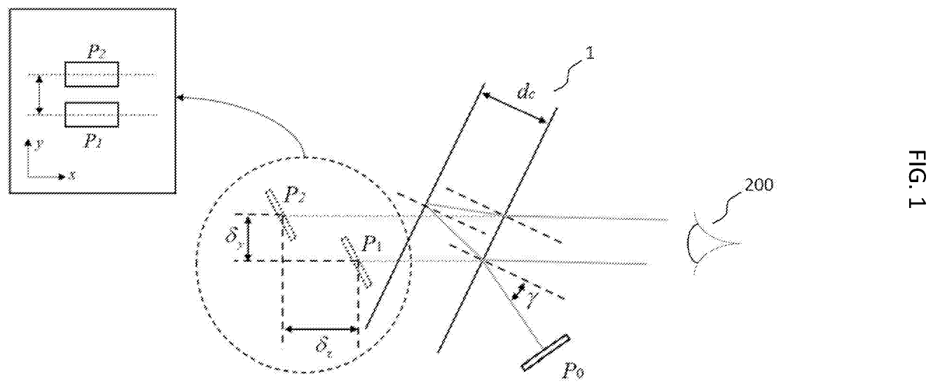

FIG. 1 illustrates the concept behind the generation of a ghost image when an image p₀ is projected towards a windscreen 1 for reflection toward the eyes of an observer 200. The image p₀ is reflected from both the front surface 2 and the back surface 3 of the windscreen 1 towards the observer 200—resulting in the generation of a primary image p₁ on a first image plane and a ghost image p₂ on a second image plane. The windscreen 1 is characterised by several parameters: the refractive index of the windscreen n, the thickness of the windscreen d_{c} and the tilting angle of the windscreen α. These factors define the transverse displacement δ_{y} and the longitudinal displacement δ_{z} between the primary image reflected by the front surface 2 of the windscreen 1 and the ghost image reflected by the back surface 3 of the windscreen 1.

The relationships are given by following equations:

$${δ}_{Z} = \frac{2 {d}_{c}}{\sqrt{{n}^{2} - {sin}^{2} γ}} ( n - \frac{{sin}^{2} γ}{{n}^{2}} ) \qquad ( 1 )$$

$${δ}_{y} = \frac{2 {d}_{c} cos γ sin γ}{\sqrt{{n}^{2} - {sin}^{2} γ}} \qquad ( 2 )$$

where γ is the incident angle of the light beam out from the HUD system 10. In practical situations, the longitudinal displacement is usually much smaller compared with the projection distance, thus making it less discernible to the observer. On the other hand, the transverse displacement is the one discerned by the observer, which only exits along the vertical direction or y direction as illustrated in FIG. 1. Here the vertical and horizontal direction are relative in specific setup—if the transparent reflector and the incident beam in FIG. 1 were rotated, the direction with impact changes to horizontal direction. Therefore, the direction that impacts most on the observer (i.e. that of the transverse displacement δ_{y}) is referred to as the primary direction and the perpendicular direction (that of the longitudinal displacement δ_{z}) as secondary direction going forward.

The transverse displacement δ_{y} of the ghost image (and the visibility of the ghost image to the observer 200) can be minimised by reducing the divergence of the projection beam, or in other words, locating the primary and ghost images at a long projection distance such that the angular resolution of the vertical displacement between the ghost image and the primary image is lower than the angular resolution of human eye, where the observer will regard the two images as one.

The minimum angular resolution human eyes can discern is 0.0003. If we define the apparent distance between the image and the observer as dₑᵢ, then the threshold distance at which the ghost image is not visible is given according to equation (3):

$$\frac{{δ}_{y}}{{d}_{ei}} < 0.0003 \qquad ( 3 )$$

For an given setup having incident angle to the transparent reflector of 30°, a refractive index of 1.5, and a windscreen thickness of 8 mm, the displacement of the ghost image and the primary image can be calculated to be 4.90 mm according to equation (2). Equation (3) then provides a threshold projection distance of 16.33 m. This can also be understood from the prospective of beam divergence, wherein the divergence along the primary direction is almost parallel such that the human eye will regard the ghost image and the primary image as one.

Whilst the ghost image is effectively removed using this approach, the long projection distances involved require an optical system with large a magnification power, which can be difficult to accommodate into design constraints and furthermore negatively affect the quality of the observed final image. Certain HUD systems (such as those in the automotive sector) also fundamentally require images to be projected to much shorter distances (typically around 2 m so as to appear just over the bonnet of the vehicle). It is therefore of practical value to design a system where ghost image free projection can be achieved for over a wider range of projection distances suitable for wider range of applications.

This is achieved via the use of anisotropic optics to separate the image formation along different directions, so that along the primary direction (with impact on ghost image) the image is formed at a projection distance equal to or larger than the threshold distance; while along the secondary direction (which does not impact on the ghost image), the image is formed at any particular target distance. Here “anisotropic optics” means any optical component whose optical power is directionally dependent, such as a cylindrical lens, a cylindrical mirror, or an anisotropic free form mirror or lens. For example, a cylindrical mirror has a finite optical power along one direction and no optical power along the perpendicular direction, while an anisotropic free form mirror has one optical power along one direction and another different optical power along the perpendicular direction.

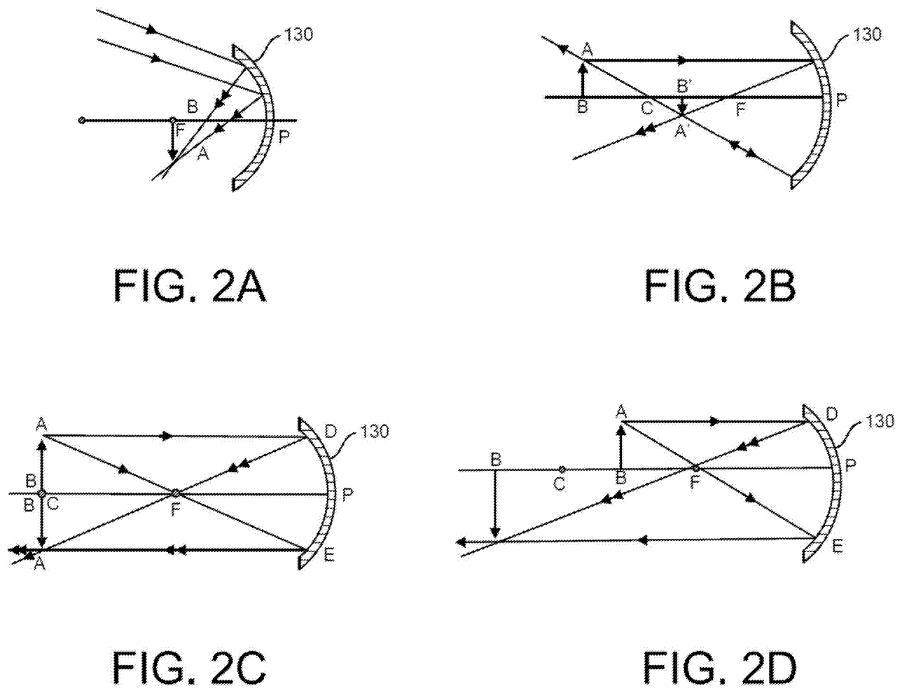

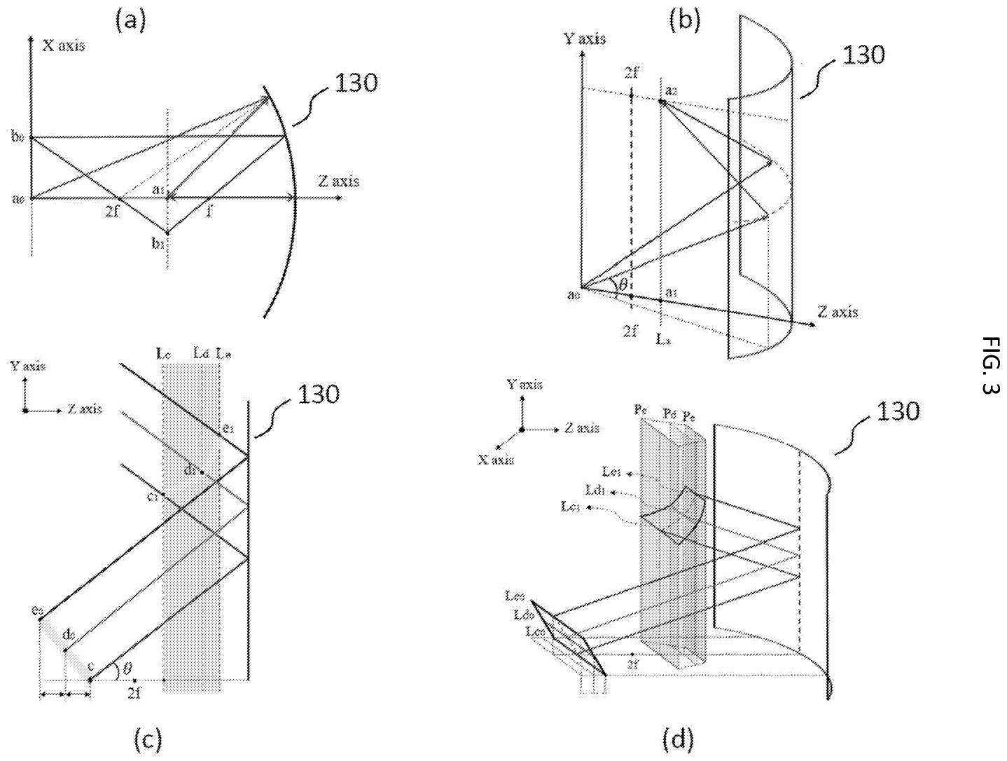

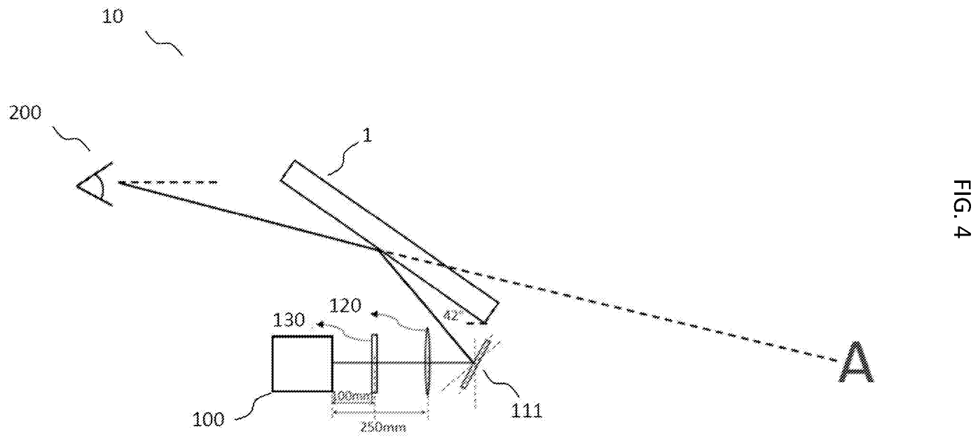

This principle of anisotropic power is illustrated in FIGS. 2 and 3, which depict the imaging properties of a parabolic concave cylindrical mirror. FIG. 2(a) depicts the case where the object is located at infinity, with the image located at the focal point, resulting in a highly diminished, real and inverted image. FIG. 2(b) depicts the case where the object is located beyond point C, with the image located between points C and F, resulting in a diminished, real and inverted image. FIG. 2(c) depicts the case where the object and image are located at point C, resulting in a real and inverted image the same size as the object. FIG. 2(d) depicts the case where the object is located between points C and F, with the image located beyond point C, which results in an enlarged, real and inverted image. Cylindrical mirrors are usually used to focus light in one dimension, who has finite curvature along one direction and infinite curvature along the other direction perpendicular to the previous one. In the following discussion concerning a parabolic cylindrical mirror, the direction with parabolic curvature is designated as the x axis, whilst the direction with infinite curvature is designated as the y axis. Therefore, the image formation along the x axis follow the rule of parabolic mirror, while the image formation along y axis follow the rule of mirror reflection.

FIGS. 3(a) and 3(b) depict the principles of image formation at a cylindrical mirror for a point source a₀, placed more than 2f away from the cylindrical mirror, where f is the focal length of the mirror. As shown, the image of a₀ is formed between f and 2f, at point a₁. As the point source shifts along x axis to position b₀, the image of b₀ appears at b₁. If length a₀b₀ represents a dimension of an image, an inverted and minified image a₁b₁ is obtained, as shown in FIG. 3(a). Considering the light beams emitted from a₀ along the y axis, for all the light beams with given angle, they are reflected by the cylindrical mirror and converge at point a₂, shown in FIG. 3(b). For light beams with any other angle, they will converge at a different point on the extended line of a₁a₂, which is defined as Lₐ. Accordingly, a point source will be imaged to one line by a cylindrical mirror, where each point on the line stands for one specific emitting angle from the point source. Combining the imaging properties shown in FIG. 3(a) and FIG. 3(b), it can be deduced that one line image along the x direction will be imaged to one plane by the cylindrical mirror, while one line image along y direction will be imaged to one line.

This analysis can be extended from a point source to a one dimensional line object and two dimensional object. FIG. 3(c) depicts a line image tilted around the y axis having three points of consideration: c₀, d₀ and e₀ emitting three parallel light beam with an angle of θ to the z axis. This results in an image of the line formed by the cylindrical mirror with corresponding points as c₁, d₁ and e₁. It can be seen that whilst, c₀, d₀ and e₀ are equally spaced along the z axis, c₁, d₁ and e₁ are no longer equally spaced owing to the mirror reflection along the y axis and parabolic lensing along the z axis. Here, the line image with c₁, d₁ and e₁ stands for the feature image for the emitting angle of θ. For other angles, c′, d′ and e′ will be the intersects of the parallel beam and line L_{c}, L_{d} and Lₑ. For a 2D object as shown in FIG. 3(d), it can be seen that for one specific angle, the line L_{c}, L_{d} and Lₑ will be imaged to Lc₁, Ld₁ and Le₁. Accordingly, the originally equally spaced three lines along the z axis, each of equal size are transformed to lines of different sizes and spacing. It can thus be observed that the image formation follows a mirror reflection rule along the y axis and a parabolic lens rule along the x and z axes.

From the analysis of the imaging property of cylindrical lens, it can be concluded that the cylindrical mirror has different imaging properties along the y axis (the axis of infinite curvature) and along the x axis (the axis of finite curvature) and z axis (the light propagation direction). For the y axis, it follows the rule of mirror reflection and for x and z axis, it follows the rule of imaging of the curved surface (for example, parabolic mirror imaging in the case discussed above). It is this anisotropic imaging property that is desirable, and whilst discussed in relation to a cylindrical mirror, the skilled person would appreciate that any other suitably anisotropic optical component could be used, such as a cylindrical lens or free form lens.

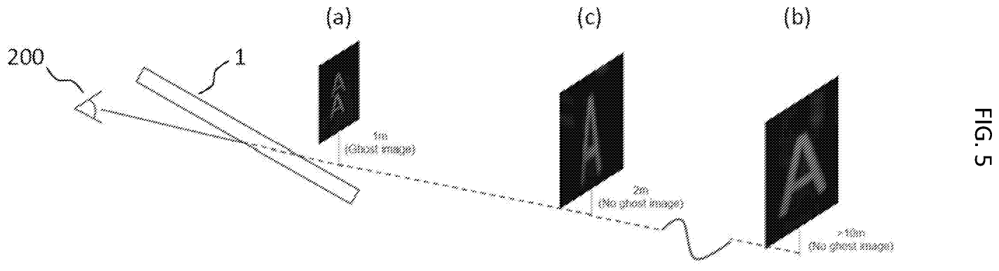

FIG. 4 depicts a HUD system 10 according to an embodiment of the invention.

The HUD system 10 is made up of a PGU 100 and a diffuser 110 (not shown), a cylindrical lens 130, a field lens 120, fold mirror 111 and a conventional windscreen 1. The PGU 100 is provided by a projector, though the skilled person would appreciate that any suitable light source and imaging means may be used provided they were capable of operating in the manner described below. Accordingly, in an embodiment the PGU 100 is formed of a laser and 2D scanning mirror, or a holographic unit which produces computer generated holograms for forming on the diffuser 110. In an alternative embodiment, the PGU 100 is a light field unit to produce 3-dimentional light field images for forming on the diffuser 110. A Digital Micromirror Device (DMD), Liquid crystal display (LCD) device, liquid crystal on silicon (LCoS) display, laser projector, light-emitting diode (LED) display, organic light-emitting diode (OLED) display, quantum-dot light-emitting diode (QLED) display and micro-light-emitting diode (μLED) display may also be used in or as the PGU 100. The skilled person would understand that in the DMD, LCoS and LCD embodiments the PGU 100 would further comprise an initial light source. In contrast, a PGU 100 comprising LEDs would not require any further light emitting components. Furthermore, in the DMD, LCoS, LCD or LED, OLED, QLED, μLED embodiments no external image realisation surface is required such that the diffuser 110 is not present.

Whilst the illustrated setup employs a windscreen 1 as a transparent reflector, the skilled person would be aware that any suitable transparent screen of finite thickness could be used, such as the visor of a pair of augmented reality goggles, or the reflector screen of a transparent reflector-type HUD.

In an embodiment, the PGU 100 is able to account for any distortion resulting from the transmission of light through components used to manipulate the optical path, such that the final images visible to the user are correctly displayed. In an embodiment, this is achieved by a software-based distortion correction module in (or otherwise in communication with) the PGU 100 that applies a pre-compensating inverse distortion to the image in the digital domain before it is projected. In an embodiment, the distortion correction module calculates the expected distortion from the optical components of the projecting optics and the display and determines the inverse distortion that must be applied such that the final image visible to a user are undistorted. This allows for the PGUs to account for asymmetries in the optical path of each image. Such pre-compensating distortions can be determined by software in a known manner. This obviates the need for any post-image generation corrections as well as bulky correction optics. Furthermore, it provides a higher degree of flexibility which can adapt to different display surfaces and optical setups.

In use, the PGU 100 projects light on to the diffuser 110 to form an image. This image is then projected through the cylindrical lens 130 and the field lens 120 and reflected by mirror 111 so as to converge the projected image onto the windscreen 1 where it is reflected towards the observer 200. The skilled person would appreciate that any suitable focussing and magnifying optics may be used, providing they meet the requirements set out below. In an embodiment, the field lens 120 is provided by a Fresnel lens. In a further embodiment, the field lens 120 is configured so as to alter the divergent beam from the PGU 100 to a near parallel beam. Whilst the illustrated embodiment uses a cylindrical lens 130 as the anisotropic optical component, the skilled person would appreciate that any suitable optical component could be used providing it demonstrated different optical/magnification powers along the primary and secondary directions. Other suitable optical components include a cylindrical mirror, a free form mirror or a free form lens. The skilled person would further appreciate that the exact order of the cylindrical lens 130 and field lens 120 depends upon their properties (i.e concave or convex) such that their relative position in the HUD system 10 is not fixed, provided they are positioned so as to intercept light emitted by the PGU 100.

Whilst the illustrated system includes a single isotropic lens (to project the image beyond the threshold distance defined by equation (3)) and a single anisotropic lens (to change the projection distance in the secondary direction perpendicular to the direction in the transverse plane where ghost image is displaced from the primary image), the skilled person would appreciate that more than one of each type of lens could be employed. In an embodiment, further optical components are included to compensate for optical aberrations, distortions or achromatic dispersion, thus improving image quality.

The path of the light from the PGU 100 transmitted through the cylindrical lens 130 and the field lens 120 and onto the windscreen 1 via mirror 111 is referred to as the optical path. The skilled person would understand that any number of intervening reflectors/lens or other optical components may be placed along the optical path between the PGU 100 and the field lens 120, or between the field lens 120 and the windscreen 1 in order to manipulate the optical path as necessary (for example, to minimize the overall size of the HUD system 10).

An aspect of the present invention is that it allows for a flexible, configurable system, which will result in the reduction of ghost images in a manner which is not installation specific. As described, by requiring the angular separation between the primary and ghost image is less than the angular resolution of the human eye, and implementing the HUD system accordingly, variations in user height, display angle, size, etc., can be accounted for.

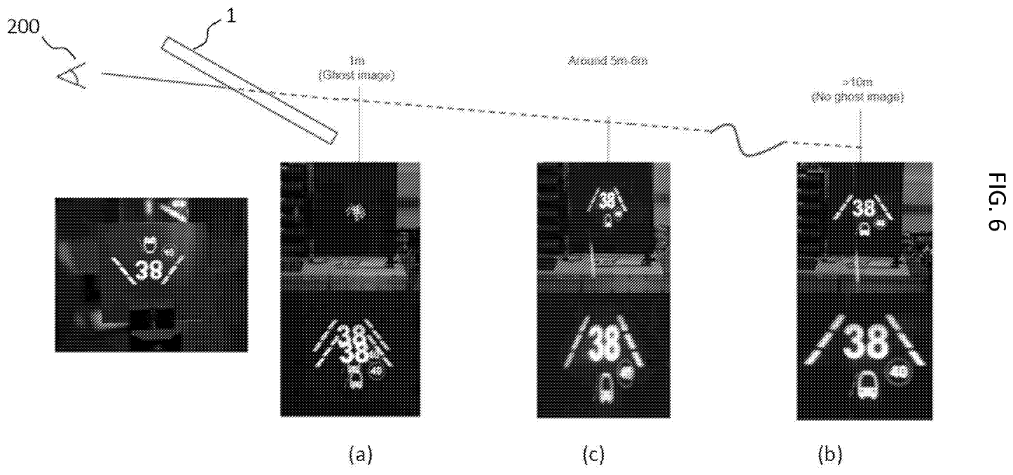

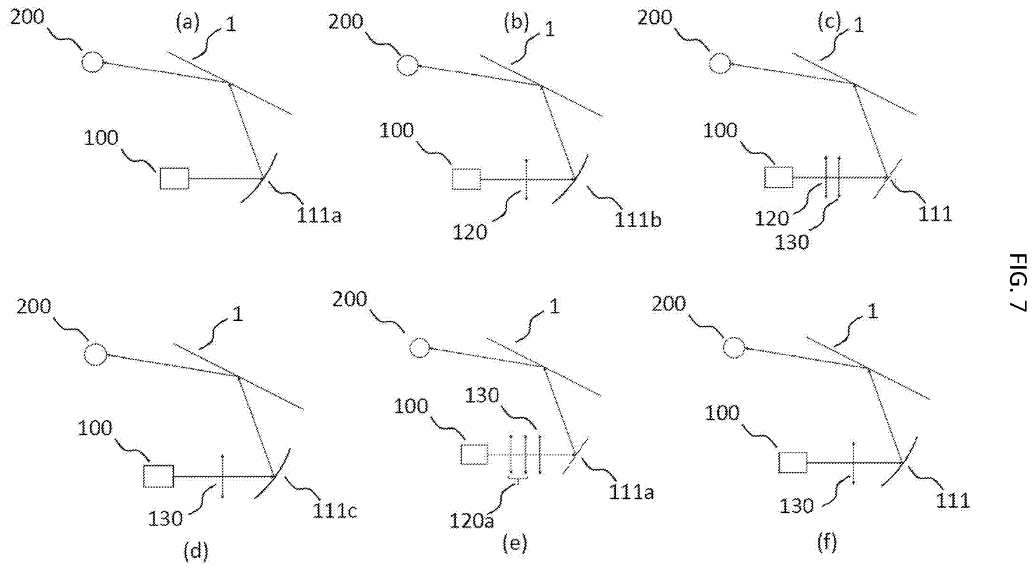

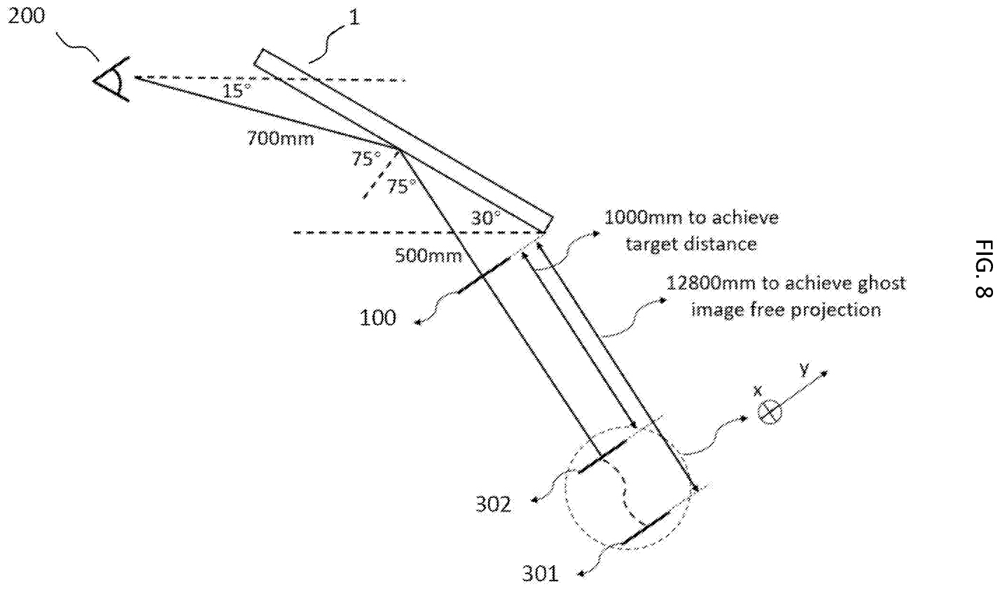

FIGS. 5 and 6 shows the image apparent to the observer for a Hub system in which (a) no filed lens 120 in present and a ghost image is apparent, (b) a field lens 120 is present and the projection distance is sufficiently large such that the ghost image is not discernible, and (c) where both a field lens 120 and cylindrical lens 130 are present and the image appears closer to the observer 200 whilst the ghost image remains undiscernible. Also apparent is a warping of the image in one direction, which results from the different optical/magnification power of the cylindrical mirror along both the primary and second directions. In an embodiment, this warping can be addressed by projecting a pre-compensated image. In an embodiment, the pre-compensated image is projected having a modified magnification or demagnification factor along one direction. In a further embodiment, the image is projected with a predetermined grid distortion compensation based on Zernike polynomials.

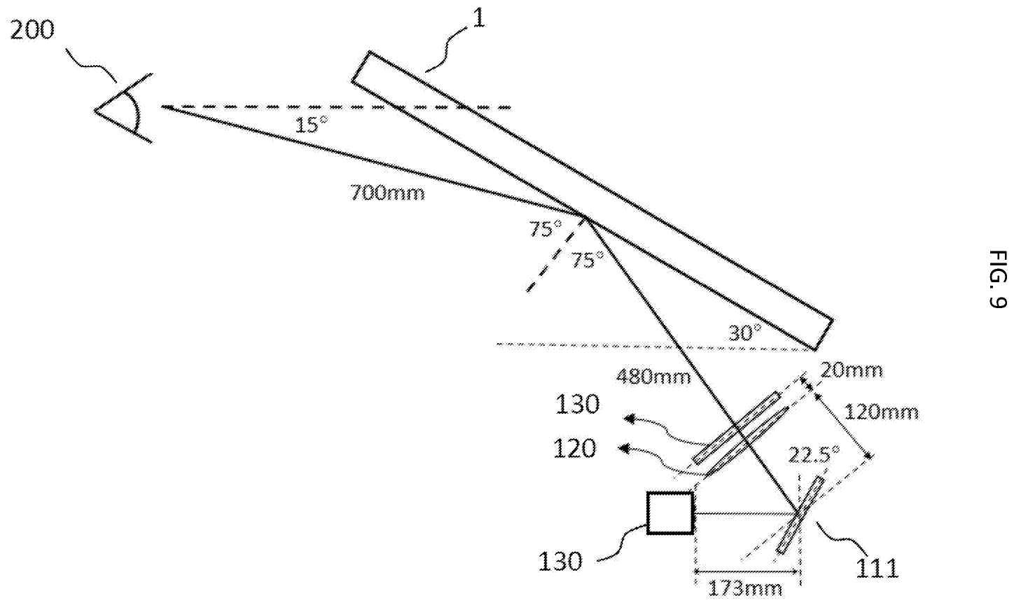

FIG. 7 illustrates alternative configurations of the HUB system 10 which include a free form mirror 111a, cylindrical mirror 111b, parabolic mirror 111c, and a field lens pair 120a. As can be seen, the use of suitably anisotropic mirror (such as free from mirror 111a, cylindrical mirror 111b and parabolic mirror 111c) can obviate the need for a dedicated anisotropic lens 130 and/or a field lens 120. This is particularly advantageous for application where installation space is limited.

### Worked Examples

For a standardised automotive application, a suitable overall target projection distance is 2.2 meters, resulting in an observed image just over the front side of the automotive bonnet. A typical windscreen is slanted at an angle of 30° and has a thickness of 6 mm and a refractive index of 1.5. The distance between the driver and the windscreen is 700 mm. The distance between the windscreen and the exit pupil of the HUD is set to 500 mm, the eye box size to 130 mm×50 mm, and the field of view to 7°×4°.

According to equation (2), the resulting transverse displacement is 4.24 mm, which requires a projection distance of approximately 14 m in order to remove the ghost image. Adopting setup of FIG. 4 (i.e. a single field lens 120 and a single cylindrical lens 130). The projected object (i.e. the image generated and realised by the PGU 100 and diffuser (if present)) is first imaged by the field lens 130 to form a virtual image (301) at a long distance. In this case, the desired distance dₑᵢ is 14 m such that the virtual image distance dᵢ will be 12.8 m according to dᵢ=dₑᵢ−dᵥ, where dᵥ is the distance between the exit pupil of the HUD system and the observer, 1.2 m in this case. Setting the focal length of the field lens 130 to be 300 mm, it is possible to calculate the distance d o between the image plane and the field lens 120 according to equation (3),

$$\frac{1}{{d}_{o}} + \frac{1}{- {d}_{i}} = \frac{1}{f} \qquad ( 3 )$$

with the negative sign of dᵢ accounting for the image being a virtual image. This gives a value of dₒ of 293.13 mm. In order to project the image at the desired distance of 2.2 m away from the observer, the second image distance to the exit pupil should be 1 m, which is achieved by using an anisotropy optical component (i.e. the cylindrical lens 130 in this embodiment).

As shown in FIG. 8, virtual image 301 is imaged by the isotropic field lens 120 with a 300 mm focal length to a long distance (14 m to the observer). Then the second virtual image 302 is formed by a second cylindrical lens 130 (which has parabolic curvature along the x direction) to a short distance (2.2 m to the observer). As the cylindrical lens 130 has anisotropic imaging properties, only the beam divergence along x direction will be altered, keeping the beam divergence along y direction unchanged. As the ghost image only exits along y direction and the beam divergence along y direction has been designed to be highly parallel so that the angular resolution of two pixels to the observer is smaller than the limitation value of human eyes, the observer will not observe the ghost image even though the second virtual image 302 is projected at a distance shorter than dₑᵢ.

In order to project the image at a projection distance of 14 m, the generated object should be positioned 293 mm away from the field lens 130 having a 300 mm focal length. The cylindrical lens 130 is introduced to image the first virtual image 301 to the second virtual image 302 along x direction as shown in FIG. 8. To achieve this, a convex cylindrical lens is employed after the field lens 120. If the distance between the field lens 120 and the convex cylindrical lens 130 is set to 20 mm, then the function of the convex cylindrical lens is to image an object placed at 12820 mm to an image placed at 1020 mm on the same side of the cylindrical lens. This provides dₒ=12820 mm, dᵢ=−1020 mm, and a focal length value according to lens function, of −1108 mm. In an embodiment, a fold mirror 111 can be employed between the optical object and the lenses in order to reduce the packaging volume, providing the setup illustrated in FIG. 9.

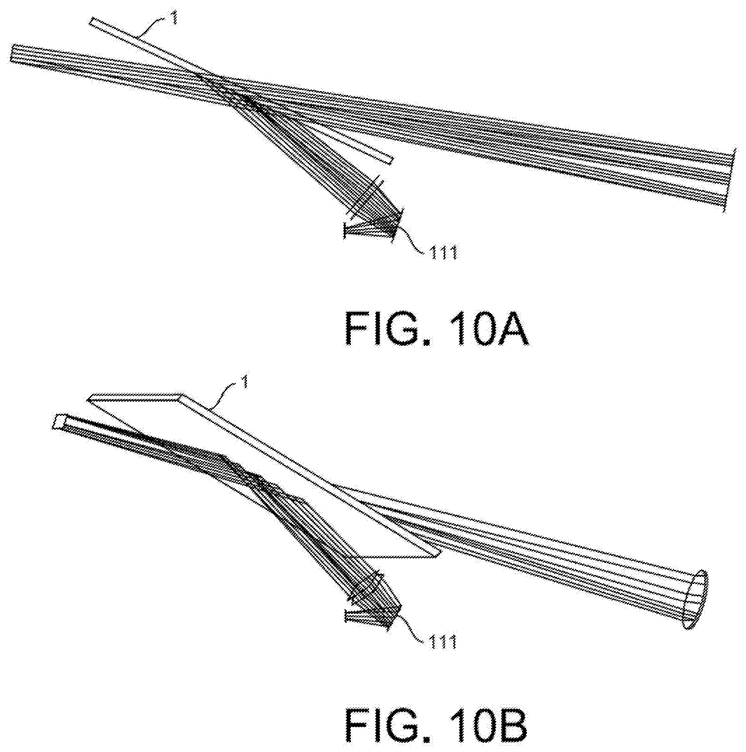

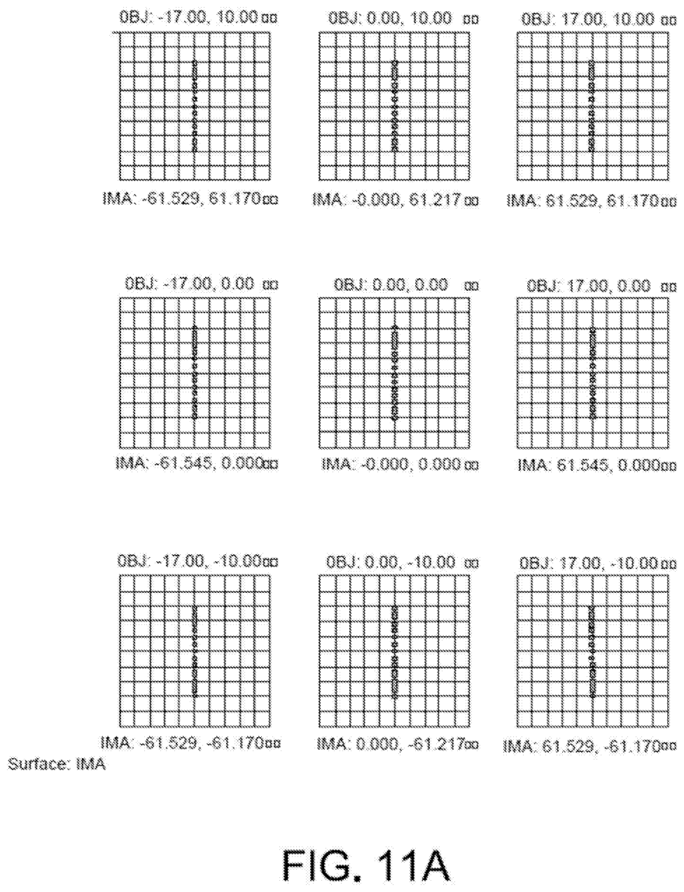

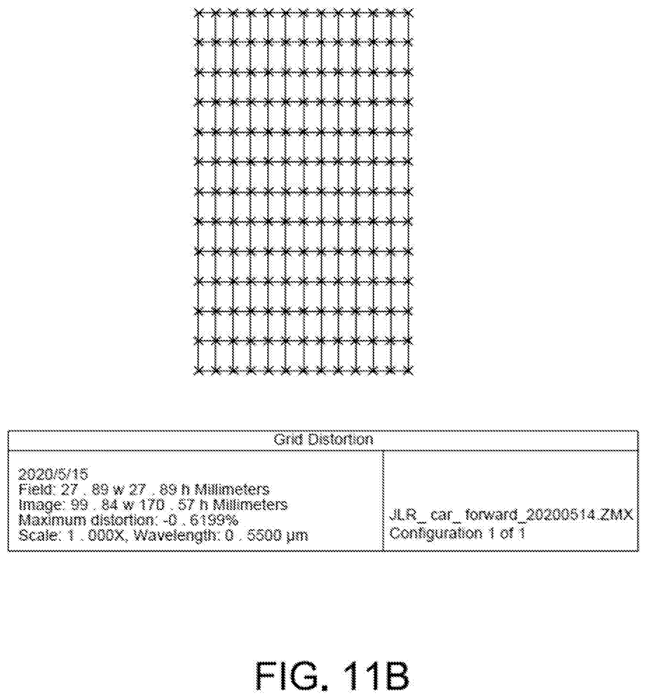

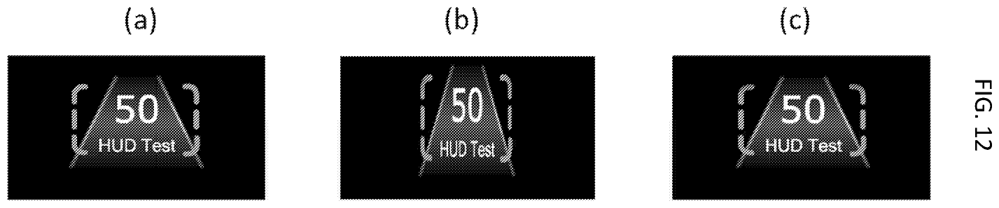

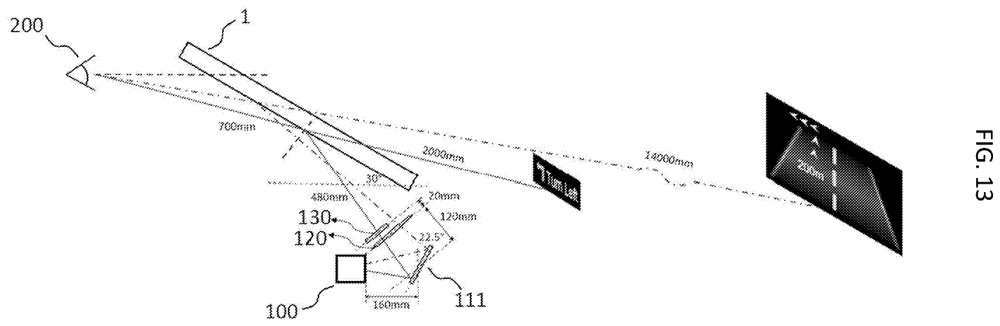

FIGS. 10, 11 and 12 show Zemax simulation results of a comparative setup having an eye box is set to 130 mm×50 mm, the simulation wavelength is 587.6 nm and the field of view is set to 7° (Horizontal)×4° (Vertical). From the Zemax simulation results, the image is projected 2.2 meters away from the observer, with a size of H268 mm×V150 mm, which equals a field of view of H7°×V4°. The image distortion ratio of the system is rather low with a value of −0.62%, but the magnification times of the system along the horizontal and the vertical direction are different, owing to the use of cylindrical lens. From the simulation results shown in FIG. 11(b), the optical magnification along horizontal direction is 3.6, while the optical magnification along vertical direction is 6.1. Therefore, if an image with normal ratio is projected, the resulting image seen by the observer will seem to be compressed along the horizontal direction. In order to obtain a projected image with the right ratio, a pre-compensate target image can be used. In this specific embodiment, the re-compensate target image would need to be resized so that the ratio of the horizontal size to the vertical size is 1.7(6.1/3.6=1.7).

In conclusion, a GIF HUD system has been designed following the principle of this invention, which meets the standard specifications of 2.2 meters projection distance and H7°×V4° FOV.

### Multi-Depth Images

It is a popular trend in automotive HUD systems that the display includes a compound image formed of multiple layers or portions each having different projection distances, where a first layer of an image is projected to a short distance for viewing comfort in an urban driving area and a second image layer is projected to a longer distance for viewing comfort in rural driving area. The same principle can also be used to approximate 3D images on the HUD.

FIG. 13 depicts an embodiment of the HUD system designed to bring about the above-described multi-layer effect wherein a first layer or portion of an image is projected to 2.2 meters whilst a second layer or image portion is projected to 14 meters.

The system parameters are identical to those described above in relation to either of FIGS. 8 and 9, as is the setup of the HUD system 10. The 2-layer projection is achieved by limiting the size of the convex cylindrical lens 130 in use. As with the embodiment of FIG. 8, the field lens 120 is used to project the entire image 14 meters away. A convex cylindrical lens 130 is arranged such that it intercepts only the light from the lower portion of the image. Due to the anisotropic imaging property of the cylindrical lens 130, the lower part will be imaged to 2 meters, whereas light received by the eye box from the upper part of the image (which has not passed through the convex cylindrical lens 130) will remain at a projection distance of 14 meters.

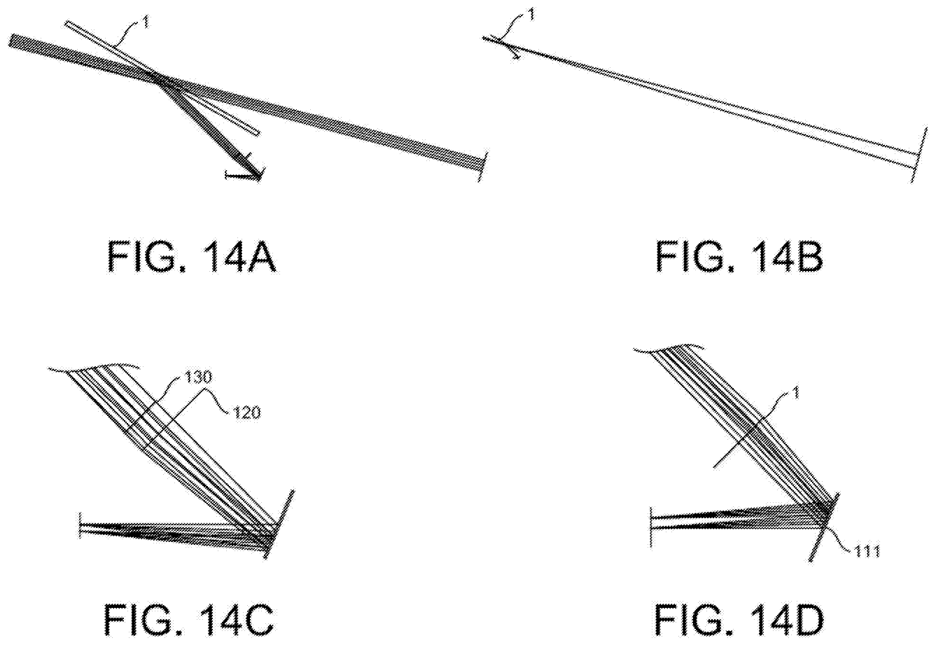

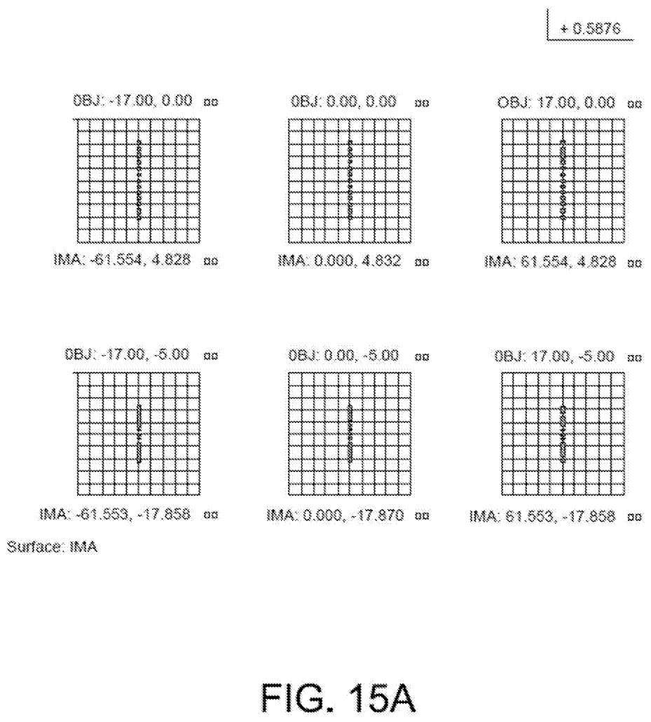

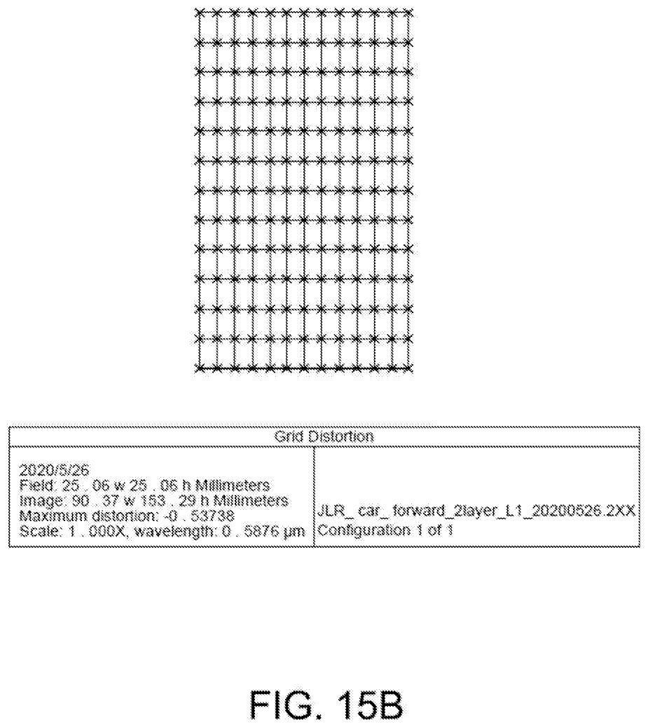

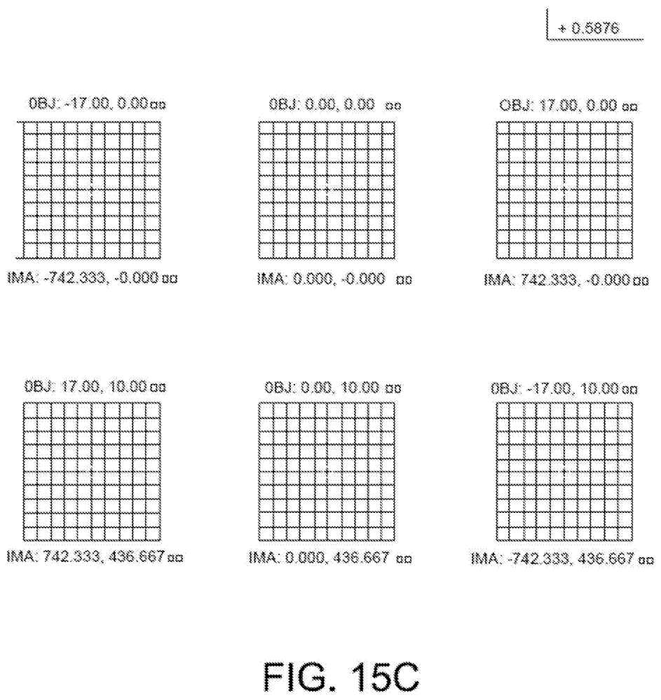

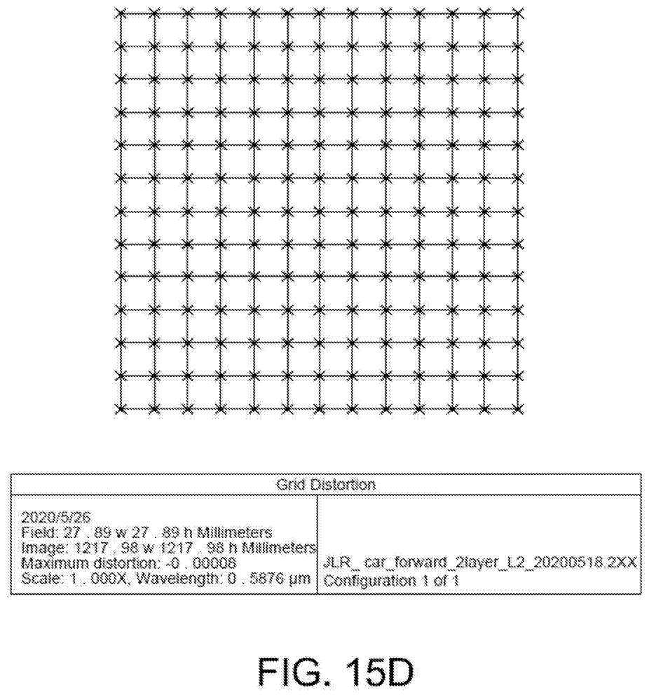

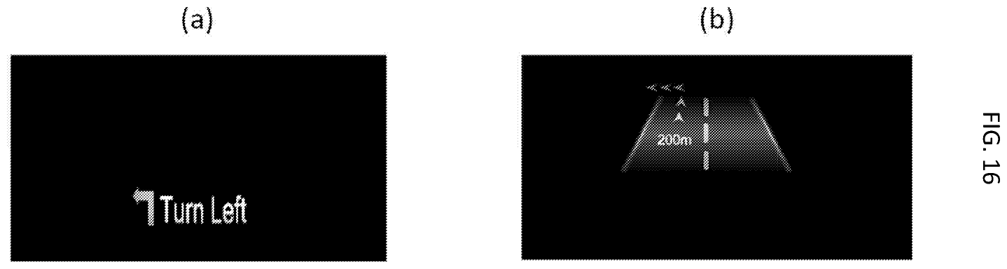

Simulation results are shown in FIGS. 14, 15 and 16. As before, it can be seen that due to the isotropic magnification of the cylindrical lens 130, the lower part of the image will be squeezed along the horizontal direction, which needs to be pre-compensated. However, since the upper image is formed with ideal normal lens, it has the same magnification along different directions and no compensation is necessary.

Accordingly, there is provided a HUD system 10 in accordance with an aspect of the invention.

1.-22. (canceled)

23. An image generation system for providing a ghost image free head-up display, the image generation system comprising:
a display screen having a front surface and a back surface;
a picture generation unit for projecting an image towards the display screen for reflection towards an eye box;
a field lens; and
an anisotropic optical component having a first optical power along a first axis and second optical power along a second axis, wherein the first and second axis are perpendicular,
wherein the picture generation unit is configured to project light through the field lens such that light is incident on the front surface of the display screen forming a first virtual image, wherein a portion of the light is transmitted through the display screen and is incident on the back surface of the display screen forming a second virtual image, wherein the first and second virtual images are offset along the first axis,
wherein the field lens is configured to project the first virtual image at a first projection distance and the second virtual image at a second projection distance such that the offset is below a threshold magnitude and the first and second virtual images are substantially overlaid as viewed from the eye box,
wherein the anisotropic optical component is configured to magnify the first and second virtual image along the second axis only.

24. The image generation system of claim 23, wherein the field lens is configured to project the first and second virtual images at the first and second projection distances such that the offset between the first and second virtual image is below a threshold angular resolution.

25. The image generation system of claim 24, wherein the threshold angular resolution is equal to the dimensions of a pixel.

26. The image generation system of claim 24, wherein the threshold angular resolution is equal to the angular resolution of the human eye.

27. The image generation system of claim 23, wherein the anisotropic optical component is provided by one of a free form mirror, free form lens, cylindrical mirror or a cylindrical lens.

28. The image generation system of claim 23, wherein the field lens is provided by one of a concave mirror, a free-form surface, a Fresnel lens, a waveguide, a diffractive optical element, a holographic optical element or one or more tapered optical fibers.

29. The image generation system of claim 23, wherein the picture generation unit comprises a light source and a spatial light modulator.

30. The image generation system of claim 23, wherein the picture generation unit comprises a projector and a diffuser for realizing a projected image.

31. The image generation system of claim 23, wherein the picture generation unit comprises a laser and a 2D scanning mirror.

32. The image generation system of claim 23, wherein the picture generation unit comprises a holographic unit to produce computer generated holograms and a diffuser for realizing the holograms.

33. The image generation system of claim 23, wherein the picture generation unit comprises one or more of an LCD device, an LED device, a micro LED device, an OLED device, or a digital light processing digital micromirror device.

34. The image generation system of claim 23, further comprising intervening optics between any of the picture generation unit, the field lens, the display screen and/or the anisotropic optical component.

35. The image generation system of claim 34, wherein the intervening optics comprise one of a fold mirror, waveguide, diffractive optical element or holographic optical element.

36. The image generation system of claim 23, further comprising an image processor in communication with the picture generation unit, wherein the image processor is configured to account for distortions caused by the optical set up such that the images appears undistorted on the display screen.

37. The image generation system of claim 23, wherein the display screen of the head-up display is a windscreen of a vehicle.

38. The image generation system of claim 23, wherein one or more of the field lens, projection unit, anisotropic optical component and/or intervening optical components (if present) are moveable relative to one another.

39. The image generation system of claim 23, wherein the image comprises a first region and a second region, wherein the system is arranged such that the first and second region are projected through the field lens whilst only the second region is projected through the anisotropic optical component.

40. A method for providing a ghost image free head-up display, the method comprising:
generating an image at a picture generation unit, said image to be rendered on a display screen for reflection towards a predetermined eye box, the display screen having a front surface and a back surface;
providing a field lens between the picture generation unit and the display screen;
providing an anisotropic optical component between the picture generation unit and the display screen, the anisotropic optical component having a first optical power along a first axis and second optical power along a second axis, wherein the first and second axis are perpendicular;
wherein a portion of the light incident on the front surface of the display screen is reflected forming a first virtual image, and a portion of the light is transmitted through the display screen and is incident on the back surface forming a second virtual image, wherein the first and second virtual images are offset along the first axis;
configuring the field lens to project the first virtual image at a first projection distance and the second virtual image at a second projection distance such that the offset is below a threshold magnitude and the first and second virtual images are substantially overlaid as viewed from the eye box; and
configuring the anisotropic optical component to magnify the first and second virtual image along the second axis only.

41. The method of claim 40, further comprising projecting the first and second virtual images at the first and second projection distances such that the offset between the first and second virtual image is below a threshold angular resolution.

42. The method of claim 41, wherein the threshold angular resolution is equal to the dimensions of a pixel or equal to the angular resolution of the human eye.
